(19) United States
(12) Patent Application Publication
(10) Pub. No.: US 2022/0052783 A1
(43) Pub. Date: Feb. 17, 2022

(54) PACKET RECONSTRUCTION AND ERROR CORRECTION FOR NETWORK ENDPOINTS

(71) Applicant: VMWARE, INC., Palo Alto, CA (US)

(72) Inventors: VASANTHA KUMAR DHANASEKAR, Pune (IN); SHIVALI SHARMA, Pune (IN); KEDAR BHALCHANDRA CHAUDHARI, Pune (IN); RAHUL KUMAR, Pune (IN)

(21) Appl. No.: 17/033,989

(22) Filed: Sep. 28, 2020

(30) Foreign Application Priority Data
Aug. 12, 2020 (IN) 202041034728

(51) Int. Cl. H04L 1/00; H04L 29/06

(52) U.S. Cl. CPC H04L 1/0041; H04L 69/22; H04L 1/0061

(57) ABSTRACT

Described herein are systems, methods, and software to manage packet reconstruction and error correction. In one implementation, a method for operating an error correction service includes receiving a packet and identifying one or more errors in the header or payload of the packet. The method further includes determining one or more corrections for the one or more errors based on predictive modeling for the packet and forwarding the packet with the one or more corrections.

### RELATED APPLICATIONS

Benefit is claimed under 35 U.S.C. 119(a)-(d) to Foreign Application Serial No. 202041034728 filed in India entitled “PACKET RECONSTRUCTION AND ERROR CORRECTION FOR NETWORK ENDPOINTS”, on Aug. 12, 2020, by VMware, Inc., which is herein incorporated in its entirety by reference for all purposes.

### BACKGROUND

Computing networks are expanding to connect additional devices to private and public networks. These devices include Internet of Things devices, such as cameras, microphones, and other sensors, as well as traditional computing systems, such as laptops, smartphones, and tablets. These devices may communicate using wired connections, such as ethernet, or may communicate using wireless connections, such as Wi-Fi or a cellular network. However, networking issues can occur as the connected devices increase with connection speed requirements.

New communication protocols have emerged that can provide higher bandwidth and connection speeds to accommodate increasing device numbers and performance requirements of connected devices. These communication protocols include wireless protocols, such as 5G and Wi-Fi 6, that, while providing higher connection speeds in some cases, can have erroneous bits and retransmission issues due to cross-signal overlaps and line of sight issues associated with the higher frequency signals. These issues can cause packets to be lost or delayed, which depending on the use case, can prevent connected devices from providing desired operations using the network.

### OVERVIEW

The technology disclosed herein manages packet reconstruction and error correction for network endpoints. In one implementation, a method of operating a packet correction service includes receiving a packet with one or more errors in the payload and/or header. In response to determining that the packet includes one or more errors, the method further includes correcting the one or more errors based on predictive modeling associated with the one or more errors and forwards the packet with the one or more corrected errors to a destination computing node.

### BRIEF DESCRIPTION OF THE DRAWINGS

FIG. 1 illustrates a computing environment to manage packet reconstruction and error correction for packets according to an implementation.

FIG. 2 illustrates an operation of a packet correction service according to an implementation.

FIG. 3 illustrates a timing diagram to implement packet correction and reconstruction according to an implementation.

FIG. 4 illustrates an operational scenario of packet correction according to an implementation.

FIG. 5 illustrates a timing diagram to implement packet correction and reconstruction according to an implementation.

FIG. 6 illustrates an operational scenario of packet correction according to an implementation.

FIG. 7 illustrates an operational scenario of communicating a packet using packet correction and reconstruction according to an implementation.

FIG. 8 illustrates a packet correction computing system according to an implementation.

### DETAILED DESCRIPTION

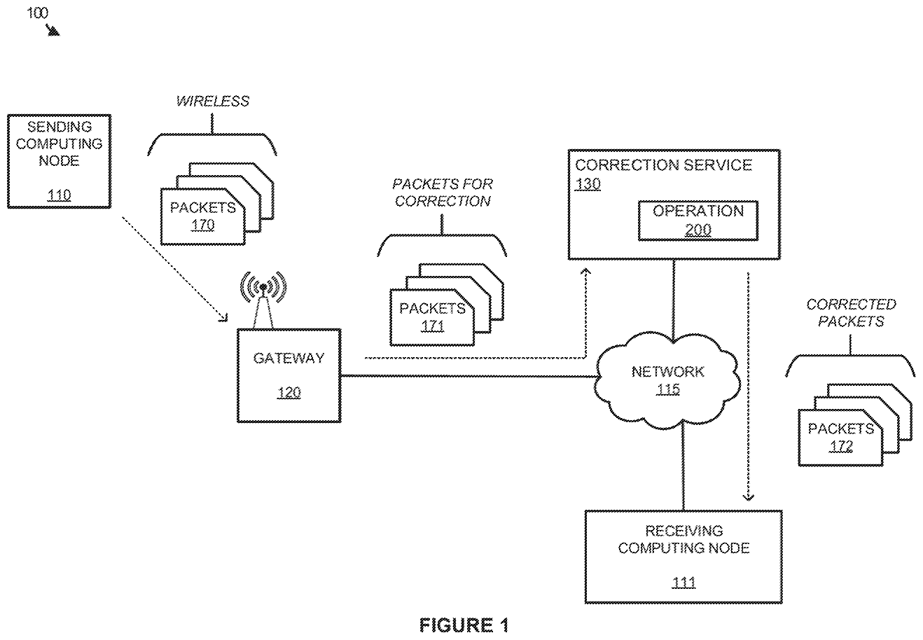

FIG. 1 illustrates a computing environment 100 to manage packet reconstruction and error correction for packets according to an implementation. Computing environment 100 includes computing nodes 110-111, gateway 120, correction service 130, network 115, and packets 170-172. Gateway 120 is represented as a wireless gateway (router) in computing environment 100 but may comprise any other switching or routing gateway. Although demonstrated as separate from gateway 120, it should be understood that correction service 130 may be implemented as part of gateway 120. In some examples, correction service 130 may operate as part of a cloud service and may execute across one or more physical computing systems.

In operation, sending computing node 110 may execute applications and services that require network communications with other computing nodes. The computing nodes may comprise physical computing systems, but may also comprise virtual machines, containers, or other containerized endpoints. For example, sending computing node 110 may generate packets to be communicated to a webserver represented by receiving computing node 111. The packets may be generated to communicate text data (e.g., a message), video or imaging data, voice data, or some other data. As an example, sending computing node 110 may represent a security camera that captures video data and communicates the video data as packets 170 to gateway 120. In some implementations, the packets may communicate encrypted data that is capable of at least partial decryption by correction service 130 and/or gateway 120.

Here, the packets generated from sending computing node 110 are communicated wirelessly to gateway 120, wherein the wireless communication may comprise Wi-Fi, 4G, 5G, or some other wireless network. As packets 170 are communicated to gateway 120, gateway 120 may perform an action to identify packets requiring correction from correction service 130. In some examples, gateway 120 may identify packets with errors using a checksum associated with the packet. A checksum performs a hash on at least a portion of the packet to generate a value of a certain length. To determine if an error occurred in the transmission of the packet, gateway 120 may perform the same hash to determine whether a value in the packet matches the value calculated by gateway 120. A match indicates that an error has not occurred, while unmatching values may indicate the presence of an error. If the checksum indicates an error with the packet, the packet may be forwarded to correction service 130 to correct the packet. These errors can be caused by cross-signal overlaps and line of sight issues associated with the higher frequency signals of the wireless networks.

As the errors associated packets are identified, gateway 120 may encapsulate the packets as packets 171 and forward the packets to correction service 130. Once received, correction service 130 may decapsulate packet and initiate error correcting actions on the packet. In one implementation, correction service 130 may determine a payload type associated with the packet and implement predictive modeling to correct one or more errors in the packet. In some implementations, correction service 130 may use neural models to identify error correction for the packet, wherein the models may consider previously communicated packets from the sending computing node, such as images, text, and the like from previously communicated packets, predictive data from other images, text, sounds, and the like, or some other model to correct errors in a packet. For example, if sending computing node 110 were representative of a video camera that streams video to receiving computing node 111, packets with errors in the payload identified by at least one checksum in the packet may be forwarded to correction service 130. Once received, correction service 130 may perform predictive modeling to correct any imaging in the video, wherein the corrections may be used to correct data for one or more pixels of an image based on the non-error portions of the image, based on previous images from the same computing node, based on other trends associated with other image references (e.g., image databases), or based on some other predictive modeling factor.

In some implementations, in addition to or in place of correcting errors in the payload of a packet, the error correction may be used to update the header of a packet. These corrections may include correcting internet protocol (IP) addresses in a packet, protocol information in a packet, port information in a packet, or some other header information in the packet. In some examples, packets may be identified that require correction based on a checksum included for the packet, wherein the checksum comprises metadata derived at least from the addressing of the packet that is used to detect errors in the packet from transmission. These checksums may be generated using one or more hash functions that intake at least a portion of the packet of a first size and generate a string of values of a second, fixed size.

In correcting the header values, correction service 130 may use information from previous packets generated by sending computing node 110, generated from other computing nodes, or some other trend or predictive modeling associated with previous packets communicated over computing networks. The trend information may be obtained from gateways 120, may be obtained from services (e.g., web services providing frequently used address information for domain name service (DNS) lookups). From the predictive modeling associated with the header, correction service 130 may update the header information and apply the checksum hashing to the corrected header to determine if the corrected header can generate the checksum in the received packet. If the checksum matches the checksum from the received packet, then correction service 130 may forward the communication to the receiving computing node. However, if the checksum does not match the checksum from the received packet, then correction service 130 may drop the packet.

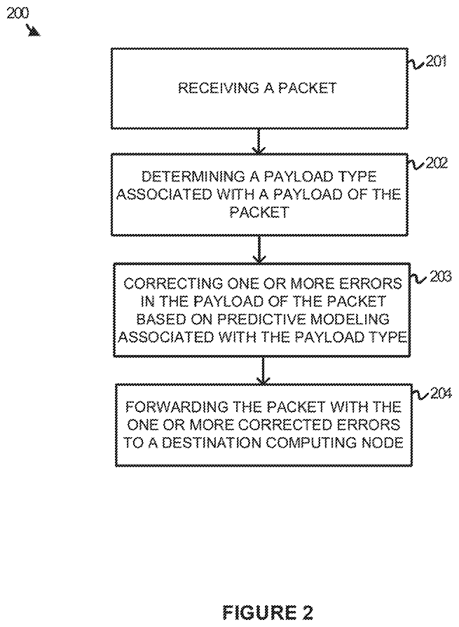

FIG. 2 illustrates an operation 200 of a packet correction service according to an implementation. The steps of operation 200 are referenced parenthetically in the paragraphs that follow with reference to systems and elements from computing environment 100 of FIG. 1. Operation 200 is referenced with correcting the payload of the packet. However, it should be understood that similar processes may be used in correcting the header of a packet.

As depicted, operation 200 includes receiving (201) a packet originating from a sending computing node. In some implementations, packets identified with one or more errors may be forwarded from a gateway receiving the packets to correction service 130, wherein correction service 130 may be provided using one or more serving computing systems, desktop computing systems, or other similar computing systems for correcting errors in packets from the sending computing node. Correction service 130 may be located in the cloud or on one or more computing systems local to the network of sending computing node 110. In some examples, gateway 120 may provide correction service 130 for packets received from sending computing node 110.

Once the packet is received, operation 200 further determines (202) a payload type associated with a payload of the packet. In some implementations, the payload may correspond to an image, video, text, or some other format type. For example, sending computing node 110 may represent a camera that streams video to receiving computing node 111. When a packet of packets 170 is identified with one or more errors by gateway 120, gateway 120 may forward the packet with the one or more errors to correction service 130, wherein correction service 130 may identify the payload type based on attributes in the payload (identifier of file type, data resembling video, imaging, voice, etc. in the payload, or other similar attributes) or may identify the payload type based on a configuration of an administrator that indicates packets from gateway 120 and/or sending computing node 110 comprise a defined payload type. In some implementations, the payload may be encrypted and at least a portion of the payload may be decrypted by correction service 130. Based on the decrypted portion of the payload, correction service 130 may identify a payload type and one or more errors in the payload and correct the errors based on the payload type. For example, an encrypted packet may be used to carry a text-based communication. Correction service 130 may decrypt the payload, identify the payload corresponds to text, and identify one or more errors in the text.

After identifying the payload type associated with the packet, correction service 130 corrects (203) one or more errors in the payload of the packet based on predictive modeling associated with the payload type. The predictive modeling may be accomplished using artificial neural networks, which can use previous packets communicated by the sending computing node, previous packets sent by other computing nodes, video/text/imaging/etc. modeling algorithms, or some other predictive modeling technique. Referring again to the video data from sending computing node 110, previous video frames from sending computing node 110 may be used to correct one or more errors in the payload of the current packet, wherein the errors may correspond to one or more pixels in the current frame. Once the one or more errors are corrected, correction service 130 forwards (204) the packet with the one or more corrected errors to the destination computing node.

In some examples, prior to forwarding the packet to the destination computing node, correction service 130 may calculate a new checksum for the packet based on the error corrections. In particular, because changes are made in the payload of the packet at least one checksum associated with the payload may be changed based on the predictive modeling. Consequently, the at least one checksum associated with the corrected portions of the packet may be calculated and updated in the packet to reflect the changes.

Although demonstrated in the previous example as updating a payload of a packet, it should be understood that similar operations may be performed to correct one or more errors in the header of a packet, wherein the errors may correspond to IP addresses, Media Access Control (MAC) addresses, ports, or some other attribute in the header. When an error is identified and forwarded to correction service 130, correction service 130 may perform predictive modeling to correct the one or more errors in the header. In some implementations, once the errors are corrected, correction service 130 may calculate a checksum associated with at least the corrected header to determine whether the newly calculated checksum matches the checksum from the originally received packet. If the checksum does not match, then the packet may be dropped. However, if the checksum for the corrected header does match the received checksum, then the packet may be forwarded to its corresponding destination. In some examples, the packet may be forwarded directly from correction service 130 to receiving computing node 111, however, it should be understood that the packet may be communicated back to gateway 120 for forwarding to receiving computing node 111.

In some implementations, gateway 120 may be configured to communicate only packets 171 that require correction to correction service 130. In other examples, gateway 120 may forward packets that require correction along with packets that do not require a correction to correction service 130. Correction service 130 may then identify the packets with one or more errors based on at least one checksum in the packets and correct (or attempt to correct) the packets with one or more identified errors.

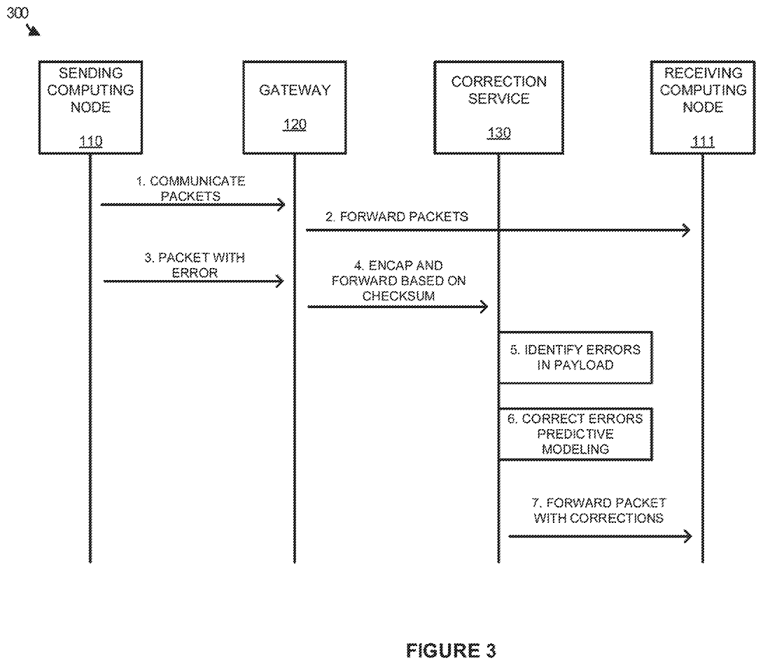

FIG. 3 illustrates a timing diagram 300 to implement packet correction and reconstruction according to an implementation. Timing diagram 300 includes sending computing node 110, gateway 120, correction service 130, and receiving computing node 111 from computing environment 100 of FIG. 1.

As depicted, sending computing node 110 sends packets, at step 1, to gateway 120, which in turn forwards, at step 2, packets to receiving computing node 111. Computing nodes 110-111 may comprise physical computing systems, virtual machines, containers, or endpoint computing node. As an example, sending computing node 110 may communicate a video data as a video call over gateway 120 to receiving computing node 111. During the communication between the computing nodes, gateway 120 may receive, at step 3, a packet with one or more errors. In some implementations, gateway 120 may detect errors with the packet based on one or more checksums included in the packet. If a checksum calculated by gateway 120 for a portion of the packet does not match the checksum that was included in the packet, then gateway 120 determines that an error exists in the packet. Once identified, the packet is encapsulated and forwarded, at step 4, to correction service 130 to provide error correction on the packet. In this example, correction service 130 is provided via a cloud computing service across one or more physical computing devices, however, it should be understood that correction service 130 may be implemented locally at gateway 120 or another computing device in the local network for gateway 120. When the service is provided locally by gateway 120, the packet may not be encapsulated prior to error correction.

When the packet with the one or more errors is received by correction service 130, correction service 130 may decapsulate the packet to identify and correct, at steps 5 and 6, errors in the payload of the packet based on predictive modeling associated with the payload type for the packet, wherein the payload type may comprise video, audio, imaging, text (such as code), or some other payload type. The predictive modeling may comprise artificial neural networks that can correct errors based on a variety of factors. The factors may include data from other packets from sending computing node 110, data from other sending computing nodes, learned information from internet databases, or some other factor or source. For example, a voice over internet protocol (VoIP) packet may include one or more errors related to an audio recording. Correction service 130 may analyze the data in the packet and determine one or more corrections based on the predictive modeling associated with voice audio. Once corrected, correction service 130 may forward, at step 7, the packet with the corrections to a corresponding receiving computing node. In some examples, correction service 130 may forward the packet directly to the receiving computing node, however, correction service 130 may encapsulate the packet to return the packet to gateway 120. In turn, gateway 120 may decapsulate the packet and forward the packet to receiving computing node 111.

In some implementations, correction service 130 may recalculate at least one checksum for the packet and replace an original checksum in the packet. This replacement checksum may be used to reflect the changes made using the predictive modeling, wherein the predictive modeling may be incapable of generating data that matches the original checksum for the packet. As a result, the updated checksum may replace to the old checksum to reflect the corrected data in the payload of the packet.

In some examples, the packet sent to correction service 130 may include and encrypted payload, wherein correction service 130 may decrypt portions of the payload to identify information about the payload (e.g., a payload type). Based on the information from decrypting at least a portion of the payload, correction service 130 may initiate operations to fix one or more errors in the packet. For example, if correction service 130 decrypted a payload for a text communication, correction service 130 may use the non-erroneous portions of the payload to identify predictive modeling for the erroneous portions of the payload. Once the one or more errors are corrected, the packet may be re-encrypted and forwarded to the destination computing node.

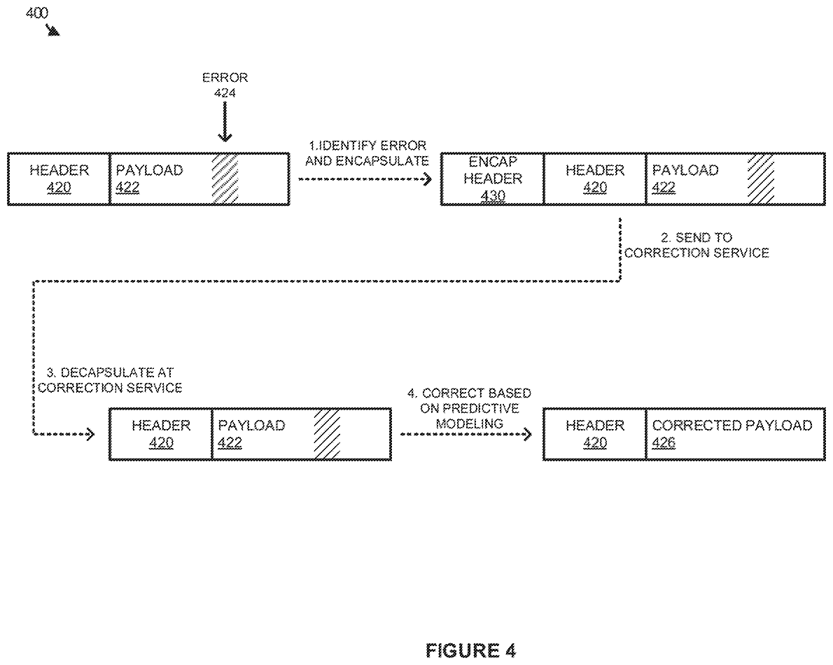

FIG. 4 illustrates an operational scenario 400 of packet correction according to an implementation. Operational scenario 400 includes header 420, payload 422, error 424, corrected payload 426, and encapsulation header 430.

In operation, a first computing element may generate a packet to be communicated to a second computing element. To provide the communication, the packet may be received by a gateway that provides routing functionality to traverse a network to the receiving computing element. In some examples, when the packet is received by the gateway, the gateway may identify, at step 1, one or more errors in the packet based on at least one checksum included in the packet and encapsulate the packet for delivery to an error correction service. Here, a packet is received by a gateway with header 430, payload 422, and error 424. When an error is detected by the computing element based on at least one checksum in the packet, the packet is encapsulated using encapsulation header 430, wherein encapsulation header 430 may include destination addressing information for the error correction service. In some examples, the correction service may be provided as a cloud service that executes on one or more computing systems, however, it should be understood that the service may be local to the network of the gateway.

Once encapsulated, the packet is sent, at step 2, to the correction service, wherein the correction service will decapsulate, at step 3, the packet for processing. Once decapsulated, the correction service may identify one or more errors and correct, at step 4, the one or more errors based on predictive modeling. As depicted, error 424 is located in payload 422, wherein payload 422 may correspond to various payload types related to video, text, image, audio, or some other payload type. Based on the type of payload, the correction service may determine one or more corrections and generate corrected payload 426 for the packet. For example, predictive modeling, which may be based on previous packets from the sending computing element, may be used to correct issues in video data such as corrupted pixels. Once corrected, the packet may be encapsulated and returned to the corresponding gateway. In other examples, the packet may be forwarded to the destination computing element without returning the packet to the gateway.

In some examples, in addition to providing the correction to the payload data, the correction service may update one or more checksums for the packet to reflect the corrected data. These checksums may be generated using a hash function that processes at least a portion of the packet and generates a value of a set length. The checksum may be used to determine whether any errors have occurred in the transmission of the packet.

In some implementations, the payload for a packet may be encrypted by the sending computing node. When the packet is received by the correction service, the correction service may decrypt at least a portion of the packet to identify a payload type and one or more errors in the packet. Once the one or more errors are identified, the correction service may initiate operations to fix the one or more errors based at least on the decrypted portion of the payload. After the errors are corrected, the correction service may encrypt the packet prior to forwarding the packet to the receiving computing node. For example, when an encapsulated packet is received from a gateway, the correction service may decapsulate the packet and initiate operations to decrypt the payload. Based on the portions of the payload that can be decrypted, the correction service may correct one or more errors in the packet. Thus, if the packet represented imaging data, the correction service may correct the imaging data based on the available decrypted data and predictive modeling for the portions that could not be decrypted. After correcting the one or more errors, the correction service may re-encrypt the packet and forward the packet to the destination computing node. This forwarding may be direct or may use the gateway as an intermediary.

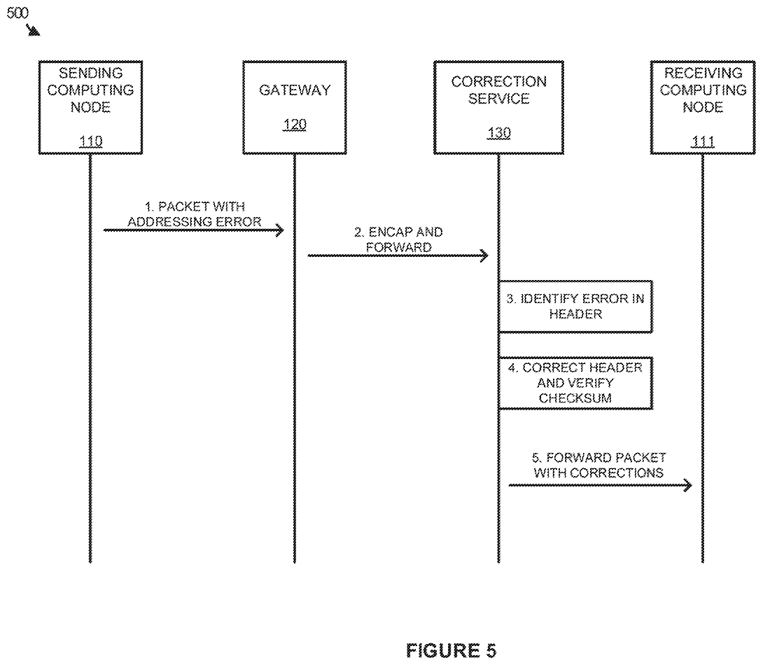

FIG. 5 illustrates a timing diagram 500 to implement packet correction and reconstruction according to an implementation. Timing diagram 500 includes sending computing node 110, gateway 120, correction service 130, and receiving computing node 111 from computing environment 100 of FIG. 1.

In operation, gateway 120 receives a packet with one or more addressing errors in the header for the packet, wherein the addressing errors may correspond to IP addresses, MAC addresses, port information, or some other error in the header for the packet. The error may be identified using at least one checksum in the packet that indicates an error corresponding to one or more values in the header. In response to receiving a packet with addressing errors, gateway 120 may encapsulate the packet, at step 2, and communicate the packet to correction service 130.

In response to receiving the encapsulated packet, correction service 130 may decapsulate the packet and identify the one or more potential errors in the addressing for the packet, at step 3. Once the errors are identified, correction service 130 may attempt to correct, at step 4, the header of the of the packet and verify the checksum. The correction of the packet may correspond to an IP address, a port, or some other information in the packet. For example, correction service 130 may identify a prefix for the destination IP address in the packet, wherein the destination is identified with a possible error. Correction service 130 may determine one or more frequently used IP addresses associated with the prefix and calculate the checksum using the one or more frequently used IP addresses. If the calculated checksum matches the checksum that was included in the original packet, then correction service 130 may determine that the header is corrected and forward, at step 5, the packet with the corrections to a receiving computing node.

In some implementations, correction service 130 may use a neural network or predictive modeling to determine the corrections that are made in the packet. The corrections may be based on frequently used information by packets from sending computing node 110, based on frequently used header information for other computing nodes, based on similarities of other packets to the current packet (port, protocol, size, and the like), or some other factor, including combinations thereof. In the example, where a checksum cannot be calculated that matches the checksum that was included in the packet, correction service 130 may discard or block the packet from being delivered.

As depicted in timing diagram 500, correction service 130 may directly forward the packet to receiving computing node 111. In other implementations, correction service 130 may return the packet to gateway 120 (encapsulated), permitting gateway 120 to forward the corrected packet to the receiving computing node. Although demonstrated as encapsulating and forwarding the packet to correction service 130, it should be understood that correction service 130 may be implemented as part of gateway 120.

In some implementations, the header error correction may occur in the IP header for a packet. However, the header error correction may occur in any Layer 2 through Layer 7 header for a packet. These layers may include the Ethernet layer, the transport layer, or some other layer of header for the packet.

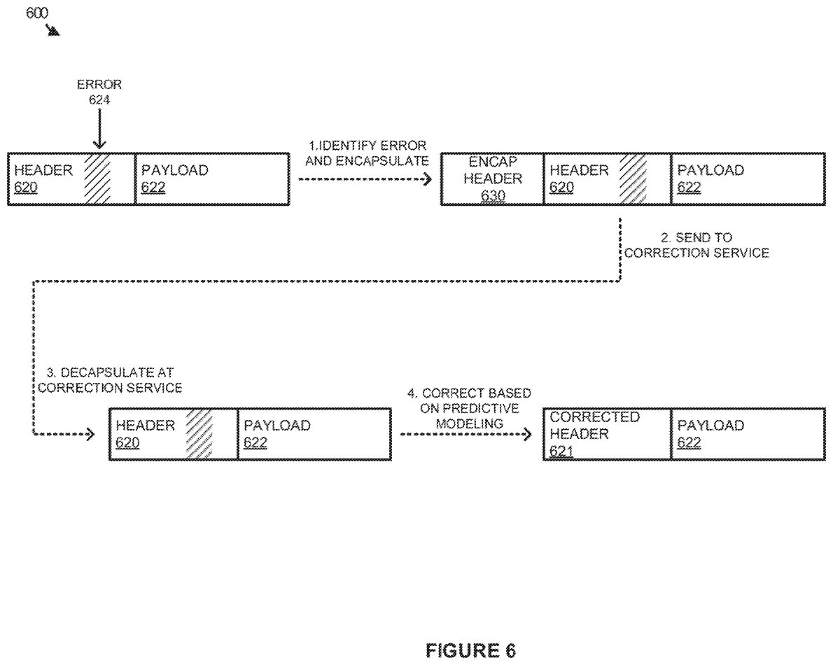

FIG. 6 illustrates an operational scenario 600 of packet correction according to an implementation. Operational scenario 600 includes a packet with header 620, payload 622, error 624, encapsulation header 630, and corrected header 621. Header 620 may represent any Layer 2 through Layer 7 header for a packet, such as an IP layer header, Ethernet layer header, transport layer header, or some other layer for the packet.

As depicted, a gateway may receive a packet a packet from a computing node and identify, at step 1, at least one error 624 in header 620, wherein the error may be identified based on a checksum associated with header 620. In response to identifying error 624, the gateway may encapsulate the packet using encapsulation header 630 and send, at step 2, the encapsulated packet to a correction service. The correction service may be located on the same local network as the gateway, may be located in a cloud computing center or server, or may be located on some other network.

When the encapsulated packet is received by the correction service, the correction service will decapsulate, at step 3, the packet and correct, at step 4, the packet based on predictive modeling associated with header 620. The predictive modeling may be used to correct IP addresses, MAC addresses, protocols, port information, or some other information in header 620. The predictive modeling may be based on packets previously sent by the same computing node, packets sent by other computing nodes, other attributes in header 620, or some other factor. In correcting the header, the correction service may determine possible corrections associated with the header. For example, if error 624 represented an error to a destination IP address. The correction service may identify a possible correction to the error based on the predictive modeling, which may be based on a prefix identified for the destination IP address and predictive modeling for the identified prefix. In some implementations, the predictive modeling may be based on frequently used IP addresses and statistical analysis from one or more computing nodes. Once a possible IP address is determined, the correction service may calculate at least one checksum associated with the packet and compare the calculated checksum to a checksum that was included in the packet. If the checksums match, then the packet may be identified as corrected and forwarded to a destination computing node.

If the checksums do not match, then the correction service may determine alternative corrections to the packet and repeat the processes for a number of attempts. If a checksum matches after an attempt, then the packet may be classified as corrected and forwarded to the destination computing node. If the checksums fail to match after the available attempts, then the packet may be dropped.

In some implementations, when a correction is determined for the packet, the packet may be encapsulated and returned to the gateway. In other examples, the packet may be forwarded directly from the correction service to the destination computing node. Although demonstrated as using a remote correction service for the packets, it should be understood that the gateway may implement the correction operations described herein.

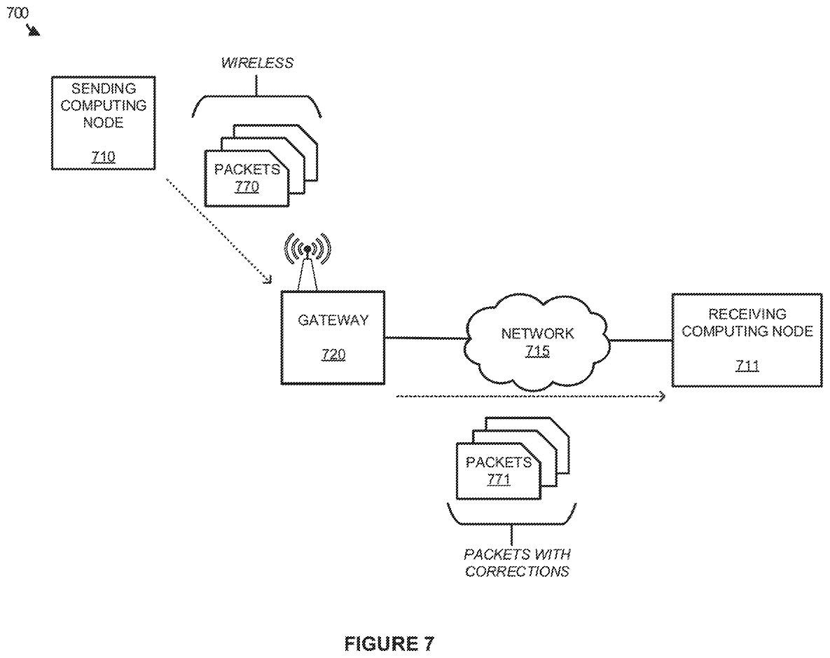

FIG. 7 illustrates an operational scenario 700 of communicating a packet using packet correction and reconstruction according to an implementation. Operational scenario 700 includes sending computing node 710, receiving computing node 711, gateway 720, network 715, and packets 770-771.

In operation, sending computing node 710 generates and communicates packets 710 that are received by gateway 720. As the packets are received, gateway 720 may determine whether one or more errors are present in the packets using one or more checksums in each of the packets. The errors may be caused by cross-signal overlaps and line of sight issues associated with the higher frequency wireless signals. When an error is identified, gateway 720 may attempt to correct the error, wherein the correction may occur in the header of the packet or the payload of the packet. In correcting the header, gateway 720 may make one or more attempts to correct errors using predictive modeling and may verify the correction using at least one checksum associated with the packet. In particular, gateway 720 may calculate a new checksum using a possible error correction and compart the new checksum to a checksum included in the received packet. When the checksums match, then the packet may be classified as corrected and forwarded to the destination. Otherwise, gateway 720 may drop the packet or make another attempt at correcting the header.

In another implementation, rather than correcting the header, gateway 720 may correct errors identified in the payload of the packet. In one example, gateway 720 may identify a payload type associated with the payload of the packet. The payload type may be identified based on traits of the payload, based on an identifier associated with sending computing node 710, based on traits of the header, or based on some other trait or factor. Based on the payload type, gateway 720 may perform predictive modeling to determine one or more corrections to the payload. Once the corrections are determined, gateway 720 may calculate at least one checksum using the corrected payload data and may forward the packet to receiving computing node 711 over network 715. For example, if sending computing node 710 captured video data to be sent to receiving computing node 711, gateway 720 may identify the type of payload for packets 770 and correct the video data in one or more of the packets using predictive modeling. Once corrected, the packets are forwarded over network 715 to receiving computing node 711.

Although demonstrated in the example of FIG. 7 as wirelessly communicating the packets to gateway 720, gateway 720 may receive the packets using wired connections. Additionally, while depicted as communicating the packet over another network 715 using gateway 720, it should be understood that similar operation may be provided to multiple devices communicating on a local network. For example, a video capture device may communicate video data to a server on the same local network for storage.

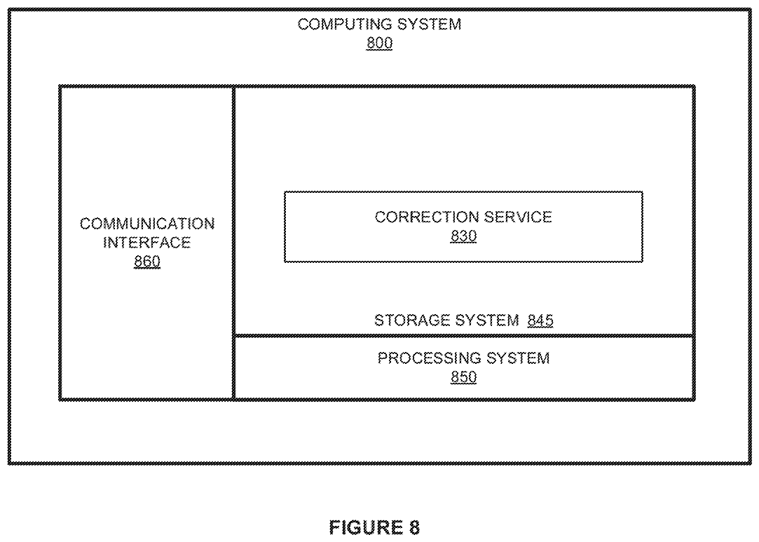

FIG. 8 illustrates a packet correction computing system 800 according to an implementation. Computing system 800 is representative of any computing system or systems with which the various operational architectures, processes, scenarios, and sequences disclosed herein for an error correction service can be implemented. Computing system 800 is an example of error correction service 130 of FIG. 1, although other examples may exist. Computing system 800 includes storage system 845, processing system 850, and communication interface 860. Processing system 850 is operatively linked to communication interface 860 and storage system 845. Communication interface 860 may be communicatively linked to storage system 845 in some implementations. Computing system 800 may further include other components such as a battery and enclosure that are not shown for clarity.

Communication interface 860 comprises components that communicate over communication links, such as network cards, ports, radio frequency (RF), processing circuitry and software, or some other communication devices. Communication interface 860 may be configured to communicate over metallic, wireless, or optical links. Communication interface 860 may be configured to use Time Division Multiplex (TDM), Internet Protocol (IP), Ethernet, optical networking, wireless protocols, communication signaling, or some other communication format—including combinations thereof. Communication interface 860 may be configured to communicate one or more gateways, such as edge routers for local networks, to correct packets received by the one or more gateways.

Processing system 850 comprises microprocessor and other circuitry that retrieves and executes operating software from storage system 845. Storage system 845 may include volatile and nonvolatile, removable and non-removable media implemented in any method or technology for storage of information, such as computer readable instructions, data structures, program modules, or other data. Storage system 845 may be implemented as a single storage device but may also be implemented across multiple storage devices or sub-systems. Storage system 845 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing system 850 is typically mounted on a circuit board that may also hold the storage system. The operating software of storage system 845 comprises computer programs, firmware, or some other form of machine-readable program instructions. The operating software of storage system 845 comprises correction service 830 capable of providing at least operation 200 of FIG. 2. The operating software on storage system 845 may further include an operating system, utilities, drivers, network interfaces, applications, or some other type of software. When read and executed by processing system 850, the operating software on storage system 845 directs computing system 800 to operate as described herein.

In one implementation, correction service 830 directs processing system 850 to receive a packet and determine one or more corrections for one or more errors identified in the packet. The packet may be received directly from a computing node or may be received in an encapsulation packet from an edge gateway. In some examples, the errors may correspond to errors in the payload and may be identified via one or more checksums in the packet. If an error exists in the payload, correction service 830 directs processing system 850 to determine a payload type associated with the payload and correct one or more errors in the payload of the packet based on predictive modeling associated with the payload type. The payload type may comprise text, image, audio, or some other type of payload. The predictive modeling may use payload data from previous packets of the same source computing node, data from other computing elements, estimation algorithms associated with the particular payload (e.g., imaging estimation techniques), or some other predictive modeling. Once the one or more errors are corrected in the packet, correction service 830 directs processing system 850 to calculate one or more checksums for the packet and add the one or more checksums to the packet. After adding the checksums, the packet may be communicated to the destination computing node or service. In some implementations, computing system 800 may directly communicate the packet to the destination computing node. In other implementations, computing systems 800 may encapsulate the packet and return the packet to a gateway that identified the error.

In some implementations, rather than correcting errors in the payload of a packet, correction service 830 directs processing system 850 to correct one or more errors in the header of the packet. The errors may correspond to IP addressing in the packet, protocol of the packet, port information, or some other information in the header of the packet. Correction service 830 may consider various predictive modeling factors including statistics associated with the current sending computing node, statistics associated with other computing nodes, other information in the header of the packet, or some other factor to correct the errors in the header. Once a correction is identified, the packet may be forwarded to the destination computing node.

In some examples, computing system 800 may identify a possible correction to the packet and calculate a checksum using the possible correction. If the calculated checksum matches a checksum that was included with the packet, then the packet may be considered corrected and forwarded to the destination computing node. When the calculated checksum does not match the checksum from the packet, the computing node may repeat determining possible corrections for a number of iterations. If the number of iterations for finding a correction is reached without finding a correction, the packet may be dropped.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

In the claims:

1. A method comprising:
receiving a packet;
determining a payload type associated with a payload of the packet;
correcting one or more errors in the payload of the packet based on predictive modeling associated with the payload type; and
forwarding the packet with the one or more corrected errors to a destination computing node for the packet.

2. The method of claim 1, wherein the payload type comprises a text payload type, an image payload type, or video content payload type.

3. The method of claim 1 further comprising:
generating a new checksum for the packet with the corrected one or more errors;
adding the new checksum to the packet; and
wherein forwarding the packet with the one or more corrected errors comprises forwarding the packet with the one or more corrected errors and the new checksum.

4. The method of claim 1, wherein receiving the packet comprises receiving the packet in an encapsulated packet from an edge gateway.

5. The method of claim 1, wherein receiving the packet comprises wirelessly receiving the packet from the first computing node.

6. The method of claim 1, wherein the predictive modeling is based at least in part on one or more previously received packets from an originating computing system for the packet.

7. The method of claim 1 further comprising:
receiving a second packet from a second computing node;
identifying one or more errors in a header of the second packet;
correcting the one or more errors in the header based on predictive modeling for the header; and
forward the second packet with the one or more corrected errors for the header to a destination computing node identified for the second packet.

8. The method of claim 7, wherein the one or more errors in the header comprise a destination addressing error, and wherein the predictive modeling predicts a destination address based on a prefix identified in association with the destination addressing error.

9. A computing apparatus comprising:
a storage system;
a processing system operatively coupled to the storage system; and
program instructions stored on the storage system that, when executed by the processing system, direct the computing apparatus to:
receive a packet;
determine a payload associated with the payload of the packet;
correct one or more errors in the payload of the packet based on predictive modeling associated with the payload type; and
forward the packet with the one or more corrected errors to a destination computing node for the packet.

10. The computing apparatus of claim 9, wherein the payload type comprises a text payload type, an image payload type, or video content payload type.

11. The computing apparatus of claim 9, wherein the program instructions further direct the computing apparatus to:
generate a new checksum for the packet with the corrected one or more errors;
add the new checksum to the packet; and
wherein forwarding the packet with the one or more corrected errors comprises forwarding the packet with the one or more corrected errors and the new checksum.

12. The computing apparatus of claim 9, wherein receiving the packet comprises receiving the packet in an encapsulated packet from an edge gateway.

13. The computing apparatus of claim 9, wherein receiving the packet comprises wirelessly receiving the packet from the first computing node.

14. The computing apparatus of claim 9, wherein the predictive modeling is based at least in part on one or more previously received packets from an originating computing system for the packet.

15. The computing apparatus of claim 9, wherein the program instructions further direct the computing apparatus to:
receive a second packet;
identify one or more errors in a header of the second packet;
correct one or more errors in the header based on predictive modeling for the header; and
forward the second packet with the one or more corrected errors for the header to a destination computing node identified for the second packet.

16. The computing apparatus of claim 9, wherein the program instructions further direct the computing apparatus to:
receive a second packet;
identify one or more errors in a header of the second packet;
determine one or more corrections for the header based on predictive modeling for the header;
calculate one or more checksums based on the one or more corrections for the header;
compare the one or more checksums to one or more second checksums identified in the second packet; and
when the one or more checksums match the one or more second checksums, forward the second packet with the one or more corrections for the header to a destination computing node identified for the second packet.

17. A method comprising:
receiving a packet;
determining one or more corrections for one or more errors in a header of the packet based on predictive modeling for the header, wherein the one or more errors comprise at least an error for a destination internet protocol (IP) address, and wherein determining the one or more corrections comprises:
identifying a prefix for the destination IP address; and
determining a corrected destination IP address based on the prefix and the predictive modeling associated with the prefix;
calculating one or more checksums based on the one or more corrections;
comparing the one or more checksums to one or more second checksums identified in the packet; and
when the one or more checksums match the one or more second checksums, forward the packet with the one or more corrections to a destination computing node identified for the packet.

18. The method of claim 17 further comprising:
when the one or more checksums do not match the one or more second checksums, blocking the packet.

19. The method of claim 17, wherein the one or more errors comprise a destination addressing error.

20. (canceled)
